(19) United States
(12) Patent Application Publication
(10) Pub. No.: US 2025/0333267 A1
(43) Pub. Date: Oct. 30, 2025

(54) SOLUTION FOR GUIDING USERS WITHIN AN ELEVATOR LOBBY AREA

(71) Applicant: KONE Corporation, Helsinki (FI)

(72) Inventors: Mika BELOV, Helsinki (FI); Tapio LAINELA, Helsinki (FI)

(73) Assignee: KONE Corporation, Helsinki (FI)

(21) Appl. No.: 19/265,071

(22) Filed: Jul. 10, 2025

Related U.S. Application Data
(63) Continuation of application No. PCT/FI2023/050080, filed on Feb. 9, 2023.

(51) Int. Cl. B66B 3/00

(52) U.S. Cl. CPC B66B 3/006

(57) ABSTRACT

A method guides users within an elevator lobby area and includes: obtaining elevator information related to a user entering the elevator lobby area via a gate device, obtaining location data of the user, obtaining continuously from a sensor system variable environment data of the elevator lobby area, selecting an indication device having an unobstructed guidance beam view from among at least two beam-based indication devices of an indication system based on the obtained location data of the user and the obtained variable environment data, and controlling the selected indication device to generate a guidance beam indicating elevator related guidance information for guiding the user. The elevator related guidance information includes the obtained elevator information. Also disclosed is a control system, an elevator lobby area guiding system, an elevator system, a computer program, and a computer-readable medium for guiding users within an elevator lobby area.

### TECHNICAL FIELD

The invention concerns in general the technical field of elevators. Especially the invention concerns guiding users within elevator lobby areas.

### BACKGROUND

In some elevator environments, elevator lobby areas with a restricted access may be used, e.g. in office buildings. The access of users into these elevator lobby areas may be controlled by using gate devices, which allow access into the elevator lobby areas only to authorized users. Unauthorized users are not allowed to access through the gate devices into the elevator lobby areas. The access control may be based using keycards; tags; identification codes; such as personal identity number (PIN) code, ID number; and/or biometric technologies, such as fingerprint, facial recognition, iris recognition, retinal scan, voice recognition, etc.

The gate devices may be communicatively coupled to an elevator control system of the elevator enabling a generation of an elevator call in response to identification of an authorized user with the gate device. Typically, user guidance information relating to the generated elevator call, e.g. elevator car serving the generated elevator call, may be displayed on a display device arranged to the gate device to guide the user to the correct elevator car. The gate devices are nowadays becoming smaller and smaller enabling reduced footprint. However, arranging the display devices to the reduced footprint gate devices is becoming more and more challenging due to a lack of the room for the display devices in the gate devices. One solution to mitigate this drawback may be using a projector-based guidance solution for providing the user guidance information. In the projector-based guidance solution, the projector generates a beam that is reflected to a floor or a wall of the elevator lobby area to provide the user guidance information. However, the use of the projector-based guidance solution may be challenging in the elevator lobby areas being crowded due to other users blocking the beam of the projector of the projector-based guidance solution.

Therefore, there is a need to develop further solutions for generating elevator guidance information for users in elevator environments comprising elevator lobby areas.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, a control system, an elevator lobby area guiding system, an elevator system, a computer program, and a computer-readable medium for guiding users within an elevator lobby area. Another objective of the invention is that the method, the control system, the elevator lobby area guiding system, the elevator system, the computer program, and the computer-readable medium for guiding users within the elevator lobby area improve elevator related guidance of a user within the elevator lobby area, especially within a congested elevator lobby area.

The objectives of the invention are reached by a method, a control system, an elevator lobby area guiding system, an elevator system, a computer program, and a computer-readable medium as defined by the respective independent claims.

According to a first aspect, a method for guiding users within an elevator lobby area is provided, wherein the method comprises: obtaining elevator information related to a user entering the elevator lobby area via a gate device, obtaining location data of the user, obtaining continuously from a sensor system comprising a plurality of sensor devices variable environment data of the elevator lobby area comprising location data of one or more temporary objects within the elevator lobby area, selecting an indication device having an unobstructed guidance beam view from among at least two beam-based indication devices of an indication system based on the obtained location data of the user and the obtained variable environment data, and controlling the selected indication device to generate a guidance beam indicating elevator related guidance information for guiding the user, wherein the elevator related guidance information comprises the obtained elevator information.

The method may further comprise: detecting based on the obtained variable environment data that the guiding beam generated by the selected indication device is at least partially blocked or is about to be at least partially blocked, selecting a second indication device having an unobstructed guidance beam view from among the at least two beam-based indication devices of the indication system based on the obtained location data of the user and the obtained variable environment data, and controlling the selected second indication device to generate a guidance beam indicating the elevator related guidance information for guiding the user.

The method may further comprise controlling the previously selected indication device to stop generating the guidance beam in response to controlling the selected second indication device to generate the guidance beam immediately or after a predefined delay.

The selection of the indication device may further comprise using static environment data of the elevator lobby area.

Alternatively or in addition, the method may further comprise controlling adjusting at least one property of the guidance beam.

Alternatively or in addition, in response to detecting that the guidance beams of the at least two beam-based indication devices of the indication system are at least partially blocked, the method may further comprise disabling the operation of the indication system.

In response to disabling the operation of the indication system, the method may further comprise controlling at least one elevator indicator device of an elevator lobby display system to generate the indication of the elevator related guidance information for guiding the user.

According to a second aspect, a control system of an elevator lobby area guiding system for guiding users within an elevator lobby area is provided, wherein the control system comprises a processing unit configured to: obtain elevator information related to a user entering the elevator lobby area via a gate device, obtain location data of the user, obtain continuously from a sensor system comprising a plurality of sensor devices variable environment data of the elevator lobby area comprising location data of one or more temporary objects within the elevator lobby area, select an indication device having an unobstructed guidance beam view from among at least two beam-based indication devices of the indication system based on the obtained location data of the user and the obtained variable environment data, and control the selected indication device to generate a guidance beam indicating elevator related guidance information for guiding the user, wherein the elevator related guidance information comprises the obtained elevator information.

The control system may further be configured to: detect based on the obtained variable environment data that the guidance beam generated by the selected indication device is at least partially blocked or is about to be at least partially blocked, select a second indication device having an unobstructed guidance beam view from among the at least two beam-based indication devices of the indication system based on the obtained location data of the user and the obtained variable environment data, and control the selected second indication device to generate a guidance beam indicating the elevator related guidance information for guiding the user.

The control system may further be configured to control the previously selected indication device to stop generating the guidance beam in response to controlling the selected second indication device to generate the guidance beam immediately or after a predefined delay.

Alternatively or in addition, the control system may further be configured to use static environment data of the elevator lobby area in the selection of the indication device.

Alternatively or in addition, the control system may further be configured to control adjusting at least one property of the guidance beam.

Alternatively or in addition, in response to detecting that the guidance beams of the at least two beam-based indication devices of the indication system are blocked, the control system may be configured to disable the operation of the indication system.

In response to disabling the operation of the indication system, the control system may further be configured to control at least one elevator indicator device of an elevator lobby display system to generate the indication of the elevator related guidance information for guiding the user.

According to a third aspect, an elevator lobby area guiding system for guiding users within an elevator lobby area is provided, wherein the elevator lobby area guiding system comprises: a gate device arrangement comprising at least one gate device, an indication system comprising at least two beam-based indication devices arranged within the elevator lobby area, a sensor system comprising a plurality of sensor devices, and a control system as described above.

According to a fourth aspect, an elevator system is provided, wherein the elevator system comprises: at least one elevator car configured to travel along a respective at least one elevator shaft, and an elevator lobby area guiding system as described above.

According to a fifth aspect, a computer program is provided, wherein the computer program comprises instructions which, when the program is executed by a computer, cause the computer to carry out the steps of the method as described above.

According to a sixth aspect, a computer-readable medium is provided, wherein the computer-readable medium comprises instructions which, when the program is executed by a computer, cause the computer to carry out the steps of the method as described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system into which an elevator lobby area guiding system may be implemented.

FIG. 2 illustrates schematically an example of entities of the elevator lobby area guiding system.

FIG. 3 illustrates schematically an example of a method for guiding users within the elevator lobby area.

FIG. 4 illustrates schematically a non-limiting example of a user entry procedure.

FIG. 5 illustrates schematically an example guidance situation.

FIG. 6A illustrates schematically another example of the method for guiding users within the elevator lobby area.

FIG. 6B illustrates schematically yet another example of the method for guiding users within the elevator lobby area.

FIG. 7 illustrates schematically another example guidance situation.

FIG. 8 illustrates schematically an example of components of a control system.

### DESCRIPTION OF THE EXEMPLIFYING EMBODIMENTS

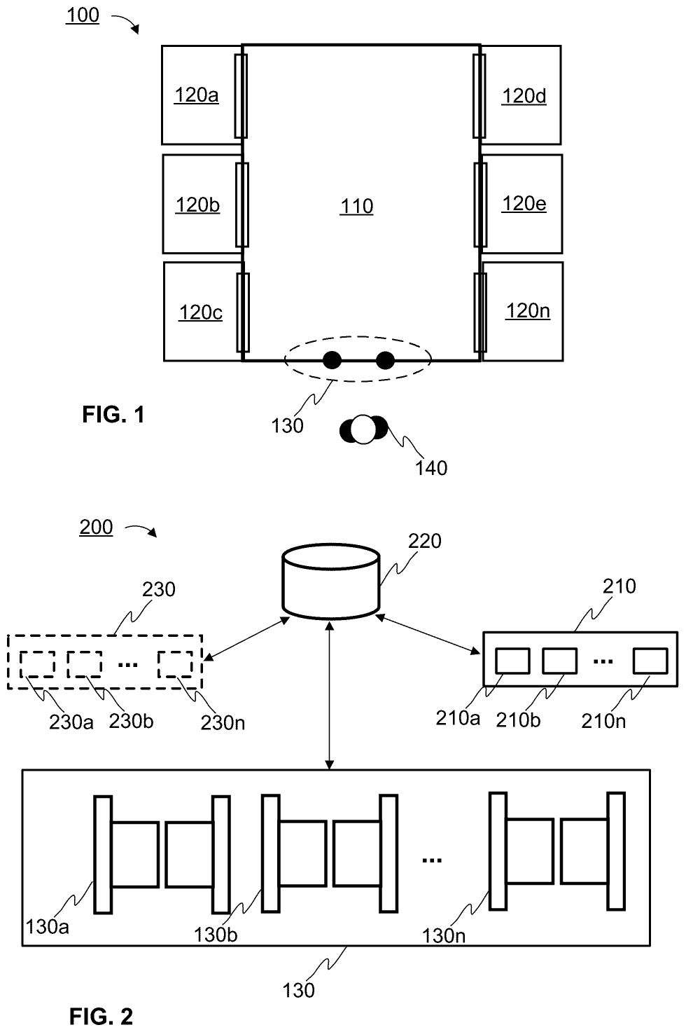

FIG. 1 illustrates schematically an example of an elevator system 100, into which an elevator lobby area guiding system 200 for guiding users 140 within an elevator lobby area 110 may be implemented. FIG. 1 illustrates top view of the example elevator system 100. The elevator system 100 comprises an elevator lobby area 110 and one or more elevators. Each elevator comprises an elevator car 120a-120n configured to travel along a respective elevator shaft. The elevator system 100 may also form an elevator group, i.e. group of two or more elevator cars 120a-120n each travelling along a separate elevator shaft configured to operate as a unit serving the same landings. The elevator system 100 further comprises one or more other known elevator related entities, e.g. an elevator control system, a hoisting system, user interface devices, a safety circuit and safety devices, elevator brakes, elevator doors, etc., which are not shown in FIG. 1 for sake of clarity. The elevator lobby area 110 is restricted by a gate device arrangement 130 of the elevator lobby area guiding system 200. The gate device arrangement 130 comprises at least one gate device 130a-130n. For sake of clarity the elevator lobby area guiding system 200 is shown in FIG. 1 only partly by illustrating only the gate device arrangement 130 of the elevator lobby area guiding system 200. The gate device arrangement 130 of the example of FIG. 1 comprises one gate device 130a-130n. The elevator lobby area guiding system 200 is discussed next by referring to FIG. 2.

FIG. 2 illustrates schematically an example of the entities of the elevator lobby area guiding system 200. The elevator lobby area guiding system 200 comprises the gate device arrangement 130, an indication system 230, a sensor system 210, and a control system 220. The control system 220 is communicatively coupled to the gate device arrangement 130, to the sensor system 210, and to the indication system 230. The communication between the control system 220 and the gate device arrangement 130 may be based on one or more known communication technologies, either wired or wireless. The communication between the control system 220 and the sensor system 210 may be based on one or more known communication technologies, either wired or wireless. The communication between the control system 220 and the indication system 230 may be based on one or more known communication technologies, either wired or wireless. The implementation of the control system 220 may be done as a stand-alone unit or as a distributed control environment between a plurality of stand-alone units providing distributed controlling resource. Preferably, the control system 220 may be implemented as the distributed control environment. The control system 220 may for example comprise at least part of the elevator control system, a common control unit of the gate device arrangement 130, a control unit of a single gate device 130a-130n of the gate device arrangement 130, an external control unit, a remote control unit, and/or some other control unit.

The gate device arrangement 130 comprises at least one gate device 130a-130n. In the example of FIG. 2 the gate device arrangement 130 of the elevator lobby area guiding system 200 comprises three gate devices 130a-130n, but it is only a non-limiting example, and the gate device arrangement 130 of the elevator lobby area guiding system 200 may comprise any other number of gate devices 130a-130n, wherein the number of gate devices 130a-130n is at least one. The at least on gate device 130a-130n may each have a reduced footprint. The reduced footprint means that the surface area required by the gate device 130a-130n is reduced, which enables that the space required by the gate device 130a-130n may be reduced.

The sensor system 210 comprises a plurality of sensor devices 210a-210n. The plurality of sensor devices 210a-210n of the sensor system 210 may comprise at least one gate device integrated sensor device, at least one elevator system integrated sensor device, and/or at least one separate sensor device. The at least one gate device integrated sensor device may be arranged to at least one gate device 130a-130n of the gate device arrangement 130, e.g. to a frame structure of the at least one gate device 130a-130n of the gate device arrangement 130. The at least one elevator system integrated sensor device may for example be arranged to at least one entity of the elevator system 100, e.g. to at least one user interface device of the elevator system 100. The at least one user interface device of the elevator system 100 may for example comprise at least one elevator call device (e.g. a landing call device, such as a landing call station (LCS), and/or a destination call device, such as a destination operation panel (DOP)), and/or at least one elevator indicator device of an elevator lobby display system (e.g. an elevator identifier device (EID) and/or a destination guide (DG) device). The at least one separate sensor device may be arranged within the elevator lobby area 110, e.g. to a ceiling, to a wall, to a floor, and/or to a pedestal within the elevator lobby area 110. The plurality of sensor devices 210a-210n may for example be people mobility detecting sensor devices based on e.g. people counting, area heatmap, Time of Flight (TOF), motion detection, and/or utilizing some mobile sensing technology for capturing people location and movement direction.

The indication system 230 comprises at least two beam-based indication devices 230a-230n arranged within the elevator lobby area 110 and configured to generate visual elevator related guidance information. The at least two beam-based indication devices 230a-230n may generate elevator related guidance information by projecting the elevator related guidance information on the floor of the elevator lobby area 110. The at least two beam-based indication devices 230a-230n may comprise at least one projector-based indication device and/or at least one laser-based indication device. The at least two beam-based indication devices 230a-230n may be arranged so that they are capable to generate the elevator related guidance information on the floor of the elevator lobby area 110. For example, the at least two beam-based indication devices 230a-230n may be arranged to a ceiling, to a wall, and/or to a pedestal within the elevator lobby area 110.

Access of users 140 into the elevator lobby area 110 may be controlled by using the gate device arrangement 130, which allows access into the elevator lobby area 110 according to one or more predefined access rules. The one or more predefined access rules may for example comprise an authorized access only-rule, according to which access into the elevator lobby area 110 is allowed only for authorized users. In case of the authorized access only, unauthorized users are not allowed to access through the gate device arrangement 130 into the elevator lobby area 110. Each gate device 130a-130n of the gate device arrangement 130 may comprise a barrier device, e.g. a door panel(s), a turnstile, a boom or any other barrier device, to prevent the unauthorized users to access into the elevator lobby area 110 via said gate device 130a-130n. The access control into the elevator lobby area 110 may for example be based on using keycards; tags; identification codes; such as personal identity number (PIN) code, ID number; and/or biometric technologies, such as fingerprint, facial recognition, iris recognition, retinal scan, voice recognition, etc. Alternatively or in addition, the one or more predefined access rules may for example comprise open access-rule, according to which access into the elevator lobby area 110 is allowed for all users to a specific destination floor, e.g. during a limited time. In case of the open access, at least one gate device 130a-130n of the gate device arrangement 130 may be controlled to be in an open state, e.g. during the limited time, to allow the access for the users. In the open state of the gate device 130a-130n the barrier device is controlled to be open, e.g. during the limited time. The open access rule may for example be used during a public event.

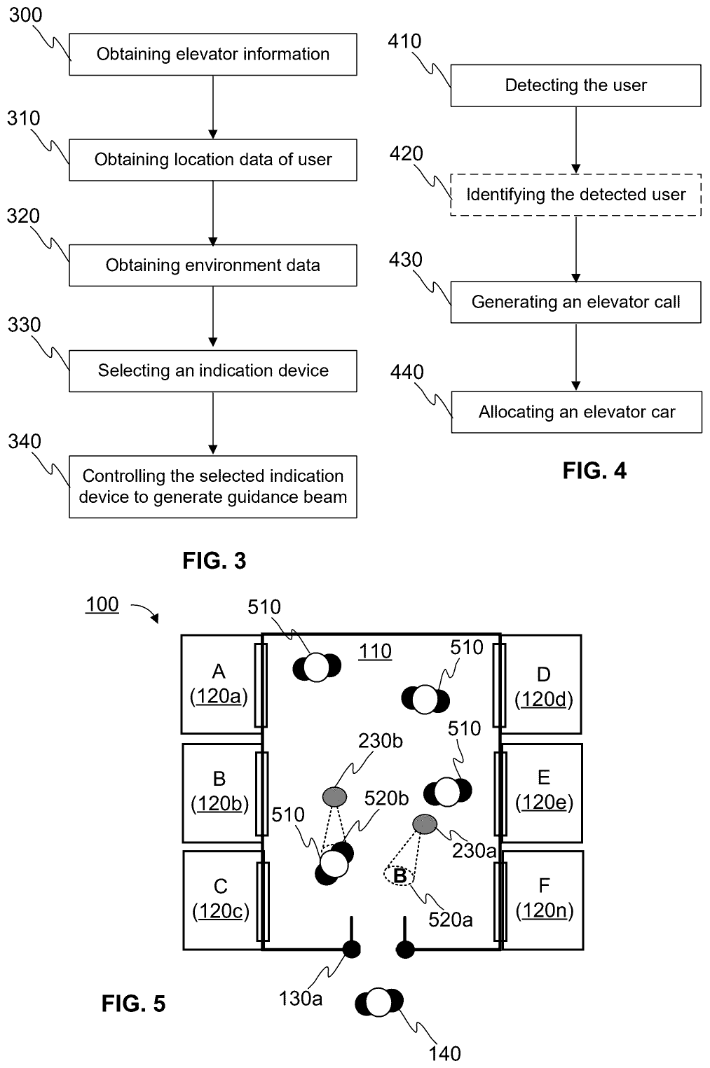

Next an example of a method for guiding users 140 within the elevator lobby area 110 is described by referring to FIG. 3. FIG. 3 schematically illustrates the invention as a flow chart. The method is described for guiding one user 140 within the elevator lobby area 110, but more than one user 140 may be guided similarly within the elevator lobby area 110.

At a step 300, the control system 220 obtains elevator information related to a user 140 entering the elevator lobby area 110 via a gate device 130a of the gate device arrangement 130. The elevator information related to the user 140 may for example comprise information related to the generated elevator call, e.g. identification information of the elevator car 120a-120n serving the generated elevator call, i.e. the elevator car 120a-120n allocated for the user 140. The elevator related information may for example be received from an elevator system related control system, e.g. from the elevator control system or an external control system integrated to the elevator system 100. The control system 220 may be communicatively coupled to the elevator system related control system. The communication between the control system 220 and the elevator system related control system may be based on one or more known communication technologies, either wired or wireless.

When the user 140 arrives to the gate device 130a for entering the elevator lobby area 110 via the gate device 130a, a user entry procedure may be performed to provide the elevator information related to the user 140 that is obtained by the control system 220 at the step 300. The user entry procedure may be based on one or more known entry actions. The user entry procedure may for example comprise detecting the user 140, optionally also identifying the user 140, generating an elevator call for the user 140 to a destination floor, and allocating an elevator car 120a-120n to the destination floor for the user 140 according to the generated elevator call. Some non-limiting examples of the user entry procedure are described next referring to FIG. 4. At a step 410, the user 140 is detected. At a step 420, e.g. in the authorized access only case, the user 140 may further be identified after the detection to check that the user 140 has authorization to access the elevator lobby area 110. The identification may for example be based on the access control examples described above. The user 140 may be identified at the gate device 130a, at an elevator system integrated device before the gate device 130a (e.g. at a DOP), or by using an external identification system before the gate device 130a. In case of the open access, the user 140 entering the elevator lobby area 110 via the gate device 130a, is only detected, but not identified. In response to the detection of the user 140 (and identification of the user 140 if needed), an elevator call is generated for the user 140 to the destination floor at a step 430. In case of the authorized only, the destination floor may for example be defined based on a predefined user profile of the identified authorized user 140, received via a user interaction at the gate device 130a (e.g. by using a user interface of the gate device 130a by the user 140) or at the elevator system integrated device (e.g. by using a user interface of the elevator system integrated device by the user 140), or defined by personnel at a reception desk, etc. In case of the open access, the destination floor is predefined. The elevator call may for example be generated to the elevator control system by the gate device 130, the elevator system integrated device, and/or any other elevator call device. At a step 440, the elevator control system allocates the elevator car 120a-120n to the destination floor for the user 140 according to the generated elevator call.

At a step 310, the control system obtains location data of the user 140. The location data of the user 140 may for example be defined based on the location of the gate device 130a via which the user 140 enters the elevator lobby area 110. The location of each gate device 130a-130n of the gate device arrangement 130 may have been stored to an internal memory unit of the control system 220 and/or to an external memory unit, e.g. a database, a memory of the elevator control system, a memory of the gate device arrangement 130, a memory of a single gate device 130a-130n of the gate device arrangement 130, and/or any other external memory unit. The control system 220 may be communicatively coupled to the external memory unit. The communication between the control system 220 and the external memory unit may be based on one or more known communication technologies, either wired or wireless. The location of each gate device 130a-130n may for example be stored to the internal memory unit and/or to the external memory unit during commissioning of the elevator lobby area guiding system 200 or commissioning of said gate device 130a-130n. The control system 220 may obtain, e.g. retrieve, the location of the gate device 130a via which the user 140 enters the elevator lobby area 110 from the internal memory unit or from the external memory unit. Alternatively or in addition, the location data of the user 140 may be obtained by the control system 220 from one or more sensor devices. The one or more sensor devices configured to provide the location data of the user 140 may be sensors 210a-210b of the sensor system 210 of the elevator lobby area guiding system 200, e.g. gate device integrated sensor devices, elevator system integrated sensor devices, and/or separate sensor devices. Alternatively, the one or more sensor devices configured to provide the location data of the user 140 may be any external sensor devices capable to provide the location data of the user 140. The location data of the user 140 obtained from the one or more sensor devices may comprise time-dependent location of the user 140. When the location data of the user 140 is defined based on the location of the gate device 130a via which the user 140 enters the elevator lobby area 110, the location of the user 140 may be defined only at the entry of the user 140 to the elevator lobby area 110. Whereas when the location data of the user 140 is obtained from the one or more sensor devices, the location data of the user 140 may be obtained at the entry of the user 140 to the elevator lobby area 110, but also when the user 140 is moving within the elevator lobby area 110, i.e. the location data of the user 140 may be obtained continuously.

At a step 320, the control system 220 obtains continuously from the sensor system 210 variable environment data of the elevator lobby area 110. The variable environment data comprises location data of one or more temporary objects 510 within the elevator lobby area 110. The location data of the one or more temporary objects 510 may comprise time-dependent locations of the one or more temporary objects 510 within the elevator lobby area 110. The location data of the one or more temporary objects 510 may further comprise: movement directions of the one or more temporary objects 510, and/or movement speeds of the one or more temporary objects 510 within the elevator lobby area 110. The one or more temporary objects 510 may for example comprise one or more other users (than the user 140 entering the elevator lobby area 110) and/or one or more non-static objects within the elevator lobby area 110. The one or more non-static objects may for example comprise one or more objects temporarily locating and/or moved within the elevator lobby area 110. The one or more non-static objects may for example comprise, but is not limited to, boxes, luggage, trolleys, strollers, and/or wheelchairs, etc. In addition to the continuously obtainable variable environment data, the control system 220 may obtain static environment data of the elevator lobby area 110. The static environment data may comprise location data of one or more static objects within the elevator lobby area 110, location data of the elevator cars 120a-120n, and/or location data of one or more entities of the elevator lobby area guiding system 200, e.g. the location of each beam-based indication device 230a-230n of the indication system 230, the location of each gate device 130a-130n of the gate device arrangement 130, and/or the location of each sensor device 210a-210n of the sensor system 210. The static environment data may for example be defined during commissioning of the elevator lobby area guiding system 200 and stored to the internal memory unit and/or to the external memory unit. The control system 220 may obtain the static environment data from the internal memory unit and/or from the external memory unit. In addition, the static environment data may be updated during the use of the elevator lobby area guiding system 200, e.g. when at least one new device (e.g. gate device 130a-130n, beam-based indication device 230a-230n, and/or sensor device 210a-210n) is added to the elevator lobby area guiding system 200, when at least one device is replaced with a new device, at least one static object is moved within the elevator lobby area 110, at least one new static object is provided to the elevator lobby area 110, and/or at least one static object is removed from the elevator lobby area 110. By means of the continuously obtained variable environment data and the known static environment data, the control system 220 is aware of, i.e. knows, the operational environment of the elevator lobby area 110.

At a step 330, the control system 220 selects an indication device 230a having an unobstructed guidance beam 520a view from among the at least two beam-based indication devices 230a-230n of the indication system 230 based on the obtained location data of the user 140 and the obtained variable environment data. In other words, the control system 220 selects the indication device 230a having an unobstructed guidance beam 520a view and being appropriate for providing elevator related guidance information, when also considering the location of the user 140. The control system 220 may further use the static environment data, e.g. the location of the at least two beam-based indication devices 230a-230n, in the selection of the indication device 230a. For example, the control system 220 may select the indication device 230a having unobstructed guidance beam 520a and being within a predefined distance from the user 140. According to another example, the control system 220 may select the indication device 230a closest to the user 140 having unobstructed guidance beam 520a. The control system 220 may further use predicted location data of the user 140 in the selection of the indication device 230a. The predicted location data of the user 140 may for example be predicting based on the location of the elevator car 120b allocated for the user 140. The location of the elevator car 120b allocated for the user 140 may for example be defined based on the identification information of the elevator car 120b allocated for the user 140 comprised in the obtained elevator information and the static environment data. An obstructed guidance beam 250a, 250b may for example be blocked by one or more temporary objects, e.g. one or more other users and/or one or more non-static objects, 510 and/or the one or more static objects. In other words, an unobstructed guidance beam view is not obstructed, i.e. blocked, for example at least by any temporary object 510 and possibly also by any static object.

At a step 340, the control system 220 controls the selected indication device 230a to generate a guidance beam 520a, e.g. a first guidance beam, indicating elevator related guidance information for guiding the user 140. The elevator related guidance information comprises at least the obtained elevator information related to the user 140. The elevator related guidance information may further comprise direction guidance information. The direction guidance information may for example comprise information related to directing (the user 140) towards the elevator car 120a-120n serving the generated elevator call, i.e. the elevator car 120a-120n allocated for the user 140. For example, the direction guidance information may comprise at least one direction indicator, e.g. an arrow, directing towards the elevator car 120a-120n allocated for the user 140. By means of the indicated elevator related guidance information the user 140 may be aware of the elevator car 120b allocated for the user 140 and possibly also the direction towards said elevator car 120b. The control system 220 may further control adjusting at least one property of the guidance beam 520a, 520b. The at least one property of the guidance beam 520a, 520b may for example be adjusted depending on the situation, e.g. congestion of the elevator lobby area 110, time of day. The at least one property of the guidance beam 520a, 520b may preferably be dynamically adjusted. The at least one property of the guidance beam 520a, 520b may comprise size, content, color, intensity, and/or guidance duration, etc. According to an example, a minimum value and a maximum value may be defined for the guidance duration, which may then be adjusted, e.g. dynamically, between the minimum value and the maximum value depending on the situation. According to another example, the intensity and/or color of the guidance beam 520a, 520b may be adjusted dynamically according to time of the day. According to yet another example, when the elevator lobby area 110 is congested, the size of the guidance beam 520a, 520b may be reduced and/or the content may be made more compact, etc. Alternatively or in addition, at least one property of the guidance beam 520a, 520b may be user dependent, e.g. the at least one property of the guidance beam 520a, 520b may be predefined for the user 140, e.g. by the user 140 himself/herself.

In FIGS. 5 and 7 example guidance situations are illustrated at different steps of the method. In the example situation of FIG. 5, the user 140 is entering the elevator lobby area 110 via the gate device 130a and the control system 220 (for sake of clarity not shown in FIG. 5) obtains the elevator information related to the user 140, the location data of the user 140 and at least the variable environment data of the elevator lobby area 110 as discussed above referring to the steps 300, 310 and 320. Based on the obtained location data of the user 140 and the obtained variable environment data, the control system 220 selects the indication device 230a, which has an unobstructed guidance beam 520a view, from among the at least two beam-based indication devices 230a-230n of the indication system 230 as discussed above referring to the step 330. The control system 220 may further use the static environment data in the selection of the indication device 230a as also discussed above. As shown in FIG. 5 the guidance beam 520a view of the indication device 230a is not blocked by any temporary object, e.g. other users, 510, while the guidance beam 520b view of the indication device 230b is blocked by another user 510. The control system 220 further controls the selected indication device 230a to generate the guidance beam 520a indicating the elevator related guidance information for guiding the user 140. In the example of FIG. 5 the elevator guidance information comprises identification information (B) of the elevator car 120b allocated for the user 140 that is indicated with the guidance beam 520a generated by the selected indication device 230a.

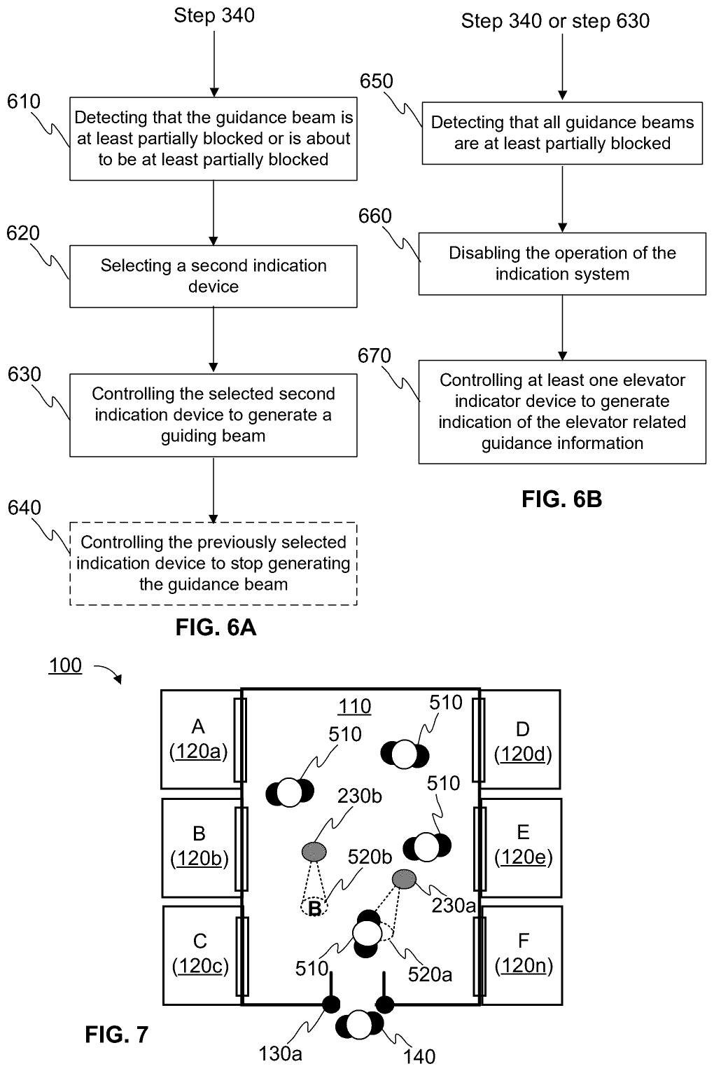

Next examples of further optional steps of the method for guiding users 140 within the elevator lobby area 110 are described by referring to FIGS. 6A and 6B.

According to an example illustrated in FIG. 6A, the control system 220 may detect based on the obtained variable environment data that the guidance beam 520a generated by the selected indication device 230a is at least partially blocked or is about to be at least partially blocked at a step 610. The guidance beam 520a may for example be blocked or be about to be blocked at least partially by the one or more temporary objects, e.g. one or more other users and/or one or more non-static objects, 510 within the elevator lobby area 110.

At a step 620, in response to the detection that the guidance beam 520a generated by the selected indication device 230a is at least partially blocked or is about to be at least partially blocked at the step 610, the control system 220 may select a second indication device 230b having an unobstructed guidance beam 520b view from among the at least two beam-based indication devices 230a-230n of the indication system 230 based on the obtained location data of the user 140 and the obtained variable environment data. In other words, the control system 220 may select the second indication device 230b having an unobstructed guidance beam 520b view and being appropriate for providing elevator related guidance information, when also considering the location of the user 140. The selection of the second indication device 230b may further be based on the static environment data. The selection may be performed similarly as described above referring to the step 330 describing the selection of the indication device 230a.

At as step 630, the control system 220 may control the selected second indication device 230b to generate the guidance beam 520b, e.g. a second guidance beam, indicating the elevator related guidance information for guiding the user 140. The controlling the selected second indication device 230b to generate the guidance beam 520b may be performed similarly as described above referring to the step 340 describing the controlling of the selected indication device 230a to generate the guidance beam 520a.

According to an example, the control system 220 may further control the previously selected indication device, e.g. the indication device 230a selected at the step 330 above, to stop generating the guidance beam 520a at a step 640 in response to controlling the selected second indication device 230b to generate the guidance beam at the step 630 above. The previously selected indication device 230a may be controlled to stop generating the guidance beam 520a immediately or after a predefined delay. Alternatively or addition, the generation of the guidance beam 520a will stop after the guidance duration has expired without any active further controlling by the control system 220, if the guidance duration of the guidance beam 520a is defined.

In the example situation of FIG. 7, the control system 220 detects based on the obtained variable environment data that the guidance beam 520a generated by the selected indication device 230a is partially blocked. The example situation of FIG. 7 follows the example situation of FIG. 5 described above. In response to the detection that the guidance beam 520a generated by the selected indication device 230a is partially blocked, the control system 220 selects a second indication device 230b having an unobstructed guidance beam 520b view based on the obtained location data of the user 140 and the obtained variable environment data. The control system 220 may further use the static environment data in the selection of the second indication device 230b as also discussed above. As shown in FIG. 7 the guidance beam 520b view of the second indication device 230b is not blocked by any temporary objects, e.g. other users, 510, while the guidance beam 520a view of the previously selected indication device 230a is partially blocked by another user 510. The control system 220 further controls the selected second indication device 230b to generate the guidance beam 520b indicating the elevator related guidance information for guiding the user 140. In the example of FIG. 7 the obtained elevator guidance information comprises identification information (B) of the elevator car 120b allocated for the user 140 that is indicated with the guidance beam 520b generated by the selected second indication device 230b.

According to an example illustrated in FIG. 6B, the control system 220 may detect at least based on the obtained variable environment data that the guiding beams 520a, 520b of the at least two beam-based indication devices 230a-230n of the indication system 230 are at least partially blocked at a step 650. In other words, the control system 220 may detect that all beam-based indication devices 230a-230n of the indication system 230 are at least partially blocked, e.g. by one or more temporary objects 510.

In response to detecting that the guidance beams 520a, 520b of the at least two beam-based indication devices 230a-230n of the indication system 230 are at least partially blocked at the step 650, the control system 220 may further disable the operation of the indication system 230 at a step 660. In other words, in response to detecting that all beam-based indication devices 230a-230n of the indication system 230 are at least partially blocked, the control system 220 may disable the operation of the indication system 230. The operation of the indication system 230 may be temporally disabled.

In response to disabling the operation of the indication system 230 at the step 660, the control system 220 may further control at least one elevator indicator device (e.g. an EID and/or a DG device) of the elevator lobby display system to generate the indication of the elevator related guidance information for guiding the user 140 at a step 670.

Above the method for guiding the users 140 within the elevator lobby area 110 is describe referring to situations, where the user 140 is entering the elevator lobby area 110. The method may also be implemented for guiding the user 140 moving within the elevator lobby area 110, e.g. from the gate device 130a to the elevator car 120b allocated for the user 140, accordingly. When the user 140 is moving withing the elevator lobby area 110 towards the allocated elevator car 120b the control system 220 may further continuously obtain the location data of the user 140. The location data of the user 140 may for example be obtained from the one or more sensor devices, e.g. sensor devices 210a-210b of the sensor system 210 of the elevator lobby area guiding system 200 and/or any external sensor devices capable to provide the location data of the user 140, as described above. The control system 220 may then continuously select an indication device 230a-230n having an unobstructed guidance beam 520a, 520b view from among the at least two beam-based indication devices 230a-230n of the indication system 230 based on the continuously obtained location data of the user 140 and the obtained variable environment data similarly as described above. The control system 220 may further use the static environment data in the selection of the indication device 230a, 230b as also discussed above. In addition, in response to detecting that the guidance beams 520a, 520b of the at least two beam-based indication devices 230a-230n of the indication system 230 are at least partially blocked at the step 650, the control system 220 may further disable the operation of the indication system 230 and control at least one elevator indicator device (e.g. an EID and/or a DG device) of the elevator lobby display system to generate the indication of the elevator related guidance information for guiding the user 140 as described above.

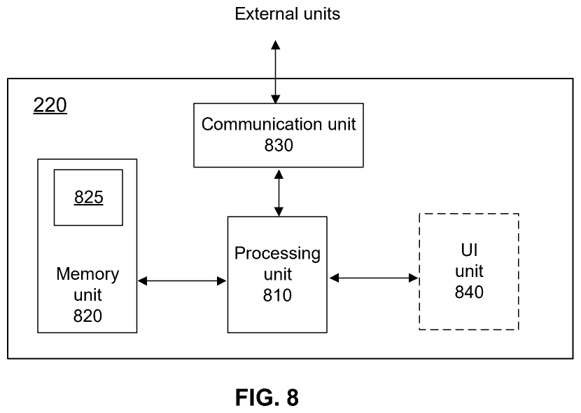

FIG. 8 illustrates schematically an example of components of the control system 220. The control system 220 may comprise a processing unit 810 comprising one or more processors, a memory unit 820 comprising one or more memories, a communication unit 830 comprising one or more communication devices, and possibly a user interface (UI) unit 840. The mentioned elements may be communicatively coupled to each other with e.g. an internal bus. The memory unit 820 may store and maintain portions of a computer program (code) 825, the elevator related guidance information, location data of the user, variable environment data, static environment data, and any other data. The computer program 825 may comprise instructions which, when the computer program 825 is executed by the processing unit 810 of the control system 220 may cause the processing unit 810, and thus the control system 220 to carry out desired tasks, e.g. one or more of the method steps described above. The processing unit 810 may thus be arranged to access the memory unit 820 and retrieve and store any information therefrom and thereto. For sake of clarity, the processor herein refers to any unit suitable for processing information and control the operation of the control system 220, among other tasks. The operations may also be implemented with a microcontroller solution with embedded software. Similarly, the memory unit 820 is not limited to a certain type of memory only, but any memory type suitable for storing the described pieces of information may be applied in the context of the present invention. The communication unit 830 provides one or more communication interfaces for communication with any other unit, e.g. the plurality of sensor devices 210a-210n of the sensor system 210, the at least one gate device 130a-130n of the gate device arrangement 130, the at least two beam-based indication devices 230a-230n of the indication system 230, the elevator control system, and/or with any other unit. The user interface unit 840 may comprise one or more input/output (I/O) devices, such as buttons, keyboard, touch screen, microphone, loudspeaker, display and so on, for receiving user input and outputting information. The computer program 825 may be a computer program product that may be comprised in a tangible nonvolatile (non-transitory) computer-readable medium bearing the computer program code 825 embodied therein for use with a computer, i.e. the control system 220.

The elevator lobby area guiding system 200 and the method discussed above improve elevator related guidance for a user 140 within the elevator lobby area 110, especially within a congested elevator lobby area 110, which in turn enables an improved user experience.

The specific examples provided in the description given above should not be construed as limiting the applicability and/or the interpretation of the appended claims. Lists and groups of examples provided in the description given above are not exhaustive unless otherwise explicitly stated.

1. A method for guiding users within an elevator lobby area, the method comprising:
obtaining elevator information related to a user entering the elevator lobby area via a gate device,
obtaining location data of the user,
obtaining continuously from a sensor system comprising a plurality of sensor devices variable environment data of the elevator lobby area comprising location data of one or more temporary objects within the elevator lobby area,
selecting an indication device having an unobstructed guidance beam view from among at least two beam-based indication devices of an indication system based on the obtained location data of the user and the obtained variable environment data, and
controlling the selected indication device to generate a guidance beam indicating elevator related guidance information for guiding the user, wherein the elevator related guidance information comprises the obtained elevator information.

2. The method according to claim 1 further comprising:
detecting based on the obtained variable environment data that the guiding beam generated by the selected indication device is at least partially blocked or is about to be at least partially blocked,
selecting a second indication device having an unobstructed guidance beam view from among the at least two beam-based indication devices of the indication system based on the obtained location data of the user and the obtained variable environment data, and
controlling the selected second indication device to generate a guidance beam indicating the elevator related guidance information for guiding the user.

3. The method according to claim 2 further comprising controlling the previously selected indication device to stop generating the guidance beam in response to controlling the selected second indication device to generate the guidance beam immediately or after a predefined delay.

4. The method according to claim 1, wherein the selection of the indication device further comprises using static environment data of the elevator lobby area.

5. The method according to claim 1 further comprising controlling adjusting at least one property of the guidance beam.

6. The method according to claim 1, wherein in response to detecting that the guidance beams of the at least two beam-based indication devices of the indication system are at least partially blocked, the method further comprises disabling the operation of the indication system.

7. The method according to claim 6, in response to disabling the operation of the indication system, the method further comprises controlling at least one elevator indicator device of an elevator lobby display system to generate the indication of the elevator related guidance information for guiding the user.

8. A control system of an elevator lobby area guiding system for guiding users within an elevator lobby area, the control system comprising a processing unit configured to:
obtain elevator information related to a user entering the elevator lobby area via a gate device,
obtain location data of the user,
obtain continuously from a sensor system comprising a plurality of sensor devices variable environment data of the elevator lobby area comprising location data of one or more temporary objects within the elevator lobby area,
select an indication device having an unobstructed guidance beam view from among at least two beam-based indication devices of the indication system based on the obtained location data of the user and the obtained variable environment data, and
control the selected indication device to generate a guidance beam indicating elevator related guidance information for guiding the user, wherein the elevator related guidance information comprises the obtained elevator information.

9. The control system according to claim 8, further configured to:
detect based on the obtained variable environment data that the guidance beam generated by the selected indication device is at least partially blocked or is about to be at least partially blocked,
select a second indication device having an unobstructed guidance beam view from among the at least two beam-based indication devices of the indication system based on the obtained location data of the user and the obtained variable environment data, and
control the selected second indication device to generate a guidance beam indicating the elevator related guidance information for guiding the user.

10. The control system according to claim 9, further configured to control the previously selected indication device to stop generating the guidance beam in response to controlling the selected second indication device to generate the guidance beam immediately or after a predefined delay.

11. The control system according to claim 8, wherein the control system is further configured to use static environment of the elevator lobby area data in the selection of the indication device.

12. The control system according to claim 8, further configured to control adjusting at least one property of the guidance beam.

13. The control system according to claim 8, wherein in response to detecting that the guidance beams of the at least two beam-based indication devices of the indication system are blocked, the control system is configured to disable the operation of the indication system.

14. The control system according to claim 13, wherein in response to disabling the operation of the indication system, the control system is further configured to control at least one elevator indicator device of an elevator lobby display system to generate the indication of the elevator related guidance information for guiding the user.

15. An elevator lobby area guiding system for guiding users within an elevator lobby area, the elevator lobby area guiding system comprising:
a gate device arrangement comprising at least one gate device,
an indication system comprising at least two beam-based indication devices arranged within the elevator lobby area,
a sensor system comprising a plurality of sensor devices, and
a control system according to claim 8.

16. An elevator system comprising:
at least one elevator car configured to travel along a respective at least one elevator shaft, and
an elevator lobby area guiding system according to claim 15.

17. A non-transitory computer readable medium storing a computer program comprising instructions which, when the program is executed by a computer, cause the computer to carry out the steps of the method according to claim 1.

18. A non-transitory computer-readable medium comprising instructions which, when the program is executed by a computer, cause the computer to carry out the steps of the method according to claim 2.

19. The method according to claim 2, wherein the selection of the indication device further comprises using static environment data of the elevator lobby area.

20. The method according to claim 3, wherein the selection of the indication device further comprises using static environment data of the elevator lobby area.
